(19) United States
(12) Patent Application Publication
(10) Pub. No.: US 2013/0264018 A1
(43) Pub. Date: Oct. 10, 2013

(54) ROLLER CURTAIN CONTROLLER

(71) Applicant: Tser Wen CHOU, Taipei City (TW)

(72) Inventor: Tser Wen CHOU, Taipei City (TW)

(21) Appl. No.: 13/775,538

(22) Filed: Feb. 25, 2013

(30) Foreign Application Priority Data
Apr. 6, 2012 (TW) 101206228

(51) Int. Cl. E06B 9/78

(52) U.S. Cl. CPC E06B 9/78
USPC 160/319

(57) ABSTRACT

A roller curtain controller includes a cap, a collar, a locating block, a pull cord reel and an outer sleeve. The cap is recessed to forma receiving space. The cap has a restriction stem protruding from a bottom wall of the receiving space. The collar is fitted on a fixed end of the restriction stem and the locating block is fitted on a front end of the restriction stem. The pull cord reel is fitted on the collar and spaced from the bottom wall of the receiving space by the collar to form a gap so as to reduce frictional noise. The locating block is assembled with the outer sleeve. By means of the support of the locating block, a central axis of the restricting stem is prevented from being deflected under the weight of the roller curtain so that the roller curtain can be operated more smoothly.

### BACKGROUND OF THE INVENTION

1. Field of the Invention

The present invention relates generally to a roller curtain controller, which is able to reduce frictional noise in operation and keep the central axis of the restricting stem in the horizontal position. Therefore, the roller curtain can be operated more smoothly.

2. Description of the Related Art

A conventional roller curtain structure includes a roller curtain controller fitted with one end of the roller curtain for controlling the roller curtain and winding up or unwinding down the roller curtain. The roller curtain controller has a restriction stem protruding from an inner face of the cap for fitting springs thereon. A pull cord reel is fitted on one end of the restriction stem. An outer sleeve is fitted on a connection hub protruding from the front end of the pull cord reel, whereby the outer sleeve is drivable by the pull cord reel to control the roller curtain and wind up or unwind down the roller curtain. In the conventional roller curtain, the pull cord reel is fitted on the restriction stem in contact with the inner face of the cap. When rotating the pull cord reel, a frictional noise is made due to contact between the pull cord reel and the inner face of the cap. Moreover, the restriction stem is simply located by means of fixing screws. Under such circumstance, the restriction stem is likely to be pressed down and the central axis of the restriction stem is likely to deflect under the weight of the roller curtain. As a result, the roller curtain can be hardly smoothly operated.

### SUMMARY OF THE INVENTION

It is therefore a primary object of the present invention to provide a roller curtain controller for solving the operation noise problem existing in the conventional roller curtain controller. The roller curtain controller is able to minimize the frictional noise made when pulling the pull cord to wind up and unwind down the roller curtain. Accordingly, a silencing effect can be achieved.

It is a further object of the present invention to provide the above roller curtain controller for solving the operation smoothness problem existing in the conventional roller curtain controller. The locating block serves to support and locate the restriction stem so as to keep the central axis of the restricting stem in a horizontal state. In this case, during rotation of the outer sleeve, the restriction stem is prevented from being pressed downward and deflected under the weight of the roller curtain so that the roller curtain can be wound up and unwound down more smoothly.

To achieve the above and other objects, the roller curtain controller of the present invention includes a cap, a collar, a locating block, a pull cord reel and an outer sleeve. The cap is recessed to form a receiving space. The cap has a restriction stem protruding from a bottom wall of the receiving space. The collar is fitted on a fixed end of the restriction stem and the locating block is fitted on a front end of the restriction stem. The pull cord reel is fitted on the collar and spaced from the bottom wall of the receiving space of the cap by the collar to form a gap so as to reduce frictional noise in use of the pull cord reel. The locating block is assembled with the outer sleeve. By means of the support of the locating block, the central axis of the restricting stem is kept in a horizontal state and prevented from being deflected under the weight of the roller curtain so that the roller curtain can be operated more smoothly.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the present invention;

FIG. 3 is a sectional assembled view of the present invention;

FIG. 4 is a perspective view showing the installation of the present invention;

FIG. 5 is a sectional assembled view showing the installation of the present invention; and

FIG. 6 is a partially sectional assembled view showing the installation of the present invention.

### DETAILED DESCRIPTION OF THE PREFERRED EMBODIMENT

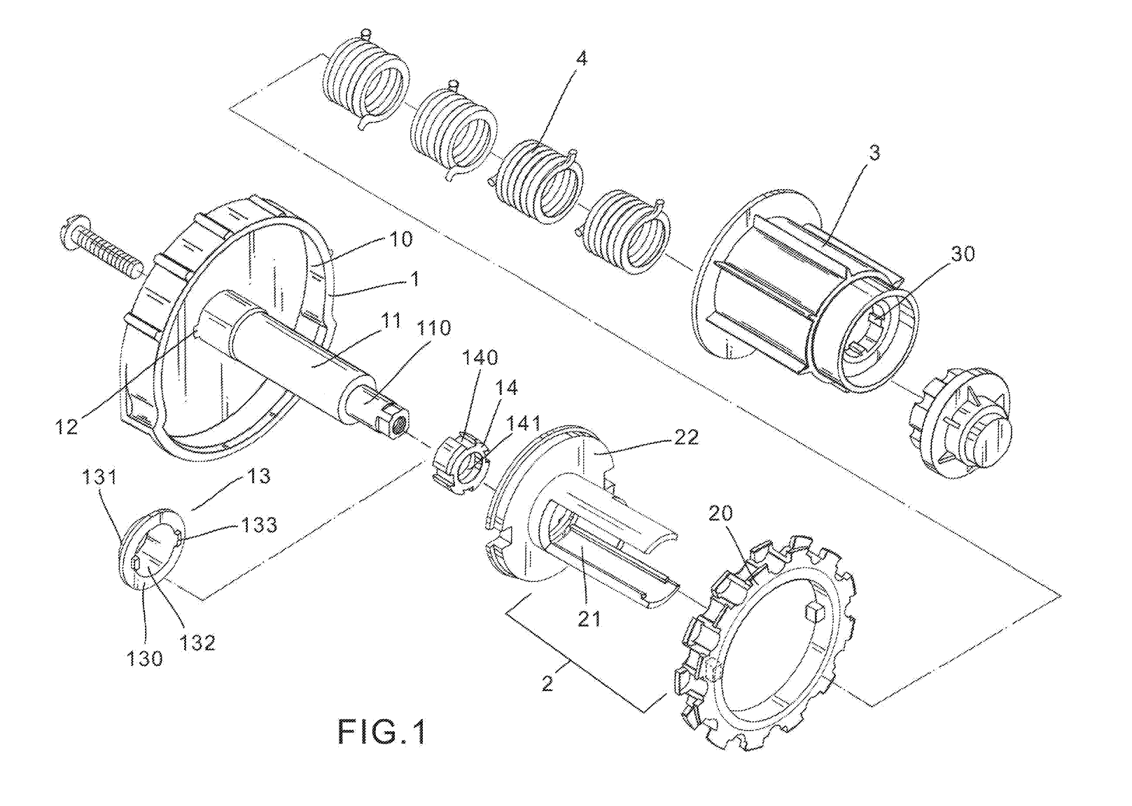

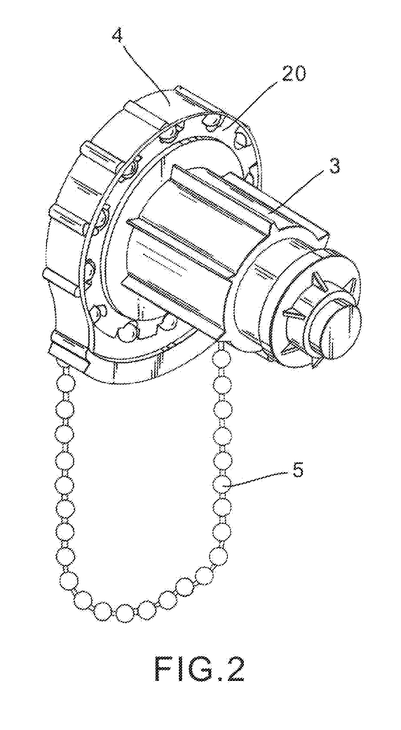

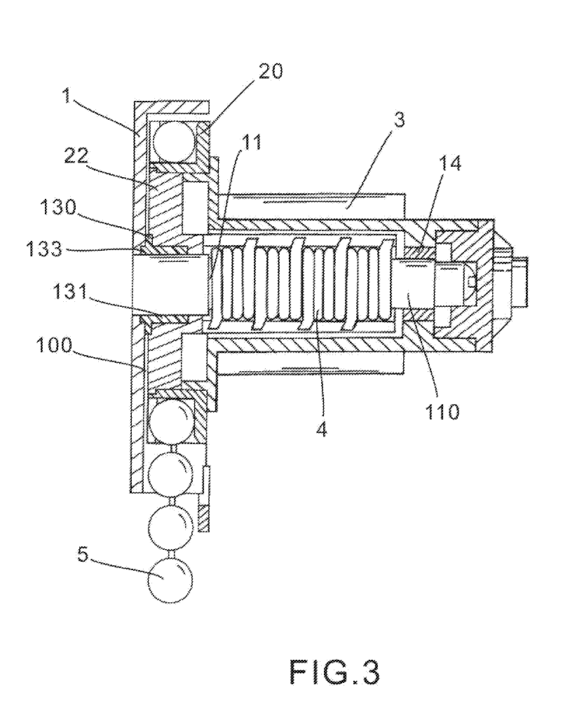

Please refer to FIGS. 1 and 2. The roller curtain controller of the present invention includes a cap 1, a pull cord reel 2 and an outer sleeve 3. The cap 1 is recessed to form a receiving space 10 in which the pull cord reel 2 is fitted. The pull cord reel 2 includes a reel seat 20 around which a bead pull cord is wound and a control seat 22 having two splits 21. Elastic members 4 are fitted on a restriction stem 11 of the cap 1. The splits 21 of the control seat 22 serve to control the elastic members 4 to tension or release the elastic members 4. The restriction stem 11 integrally protrudes from a bottom wall of the receiving space 10. Two engagement notches 12 are respectively formed on two sides of a fixed end of the restriction stem 11 for locating a collar 13 on the restriction stem 11. The collar 13 has a flange 130 and a connection section 131 protruding from the flange 130. The connection section 131 has a cylindrical body with a polished face for fitting and connecting with the control seat 22. The collar 13 is formed with a central through hole 132 for the restriction stem 11 to pass through. Two engagement blocks 133 are disposed on two sides of the through hole 132 corresponding to the engagement notches 12 at the fixed end of the restriction stem 11. By means of the engagement blocks 133, the collar 13 is engaged at the fixed end of the restriction stem 11. When the pull cord reel 2 is received in the receiving space 10 of the cap 1 under the thickness of the main body of the collar 13, a gap 100 is defined to prevent the pull cord reel 2 from contacting with the bottom wall of the receiving space 10 (as shown in FIG. 3). A front end of the restriction stem 11 is formed with a stepped structure 110 for fitting a locating block 14 thereon. The locating block 14 has a main body and multiple insertion dents 140 formed on an outer circumference of the main body. The locating block 14 is formed with a central through hole 141 for the front end of the restriction stem 11 to pass through. Accordingly, the locating block 14 is fitted on the front end of the restriction stem 11. Multiple insertion blocks 30 are disposed on an inner circumference of the outer sleeve 3. The insertion blocks 30 are correspondingly inserted in the insertion dents 140 of the locating block 14 to assemble the locating block 14 with the outer sleeve 3.

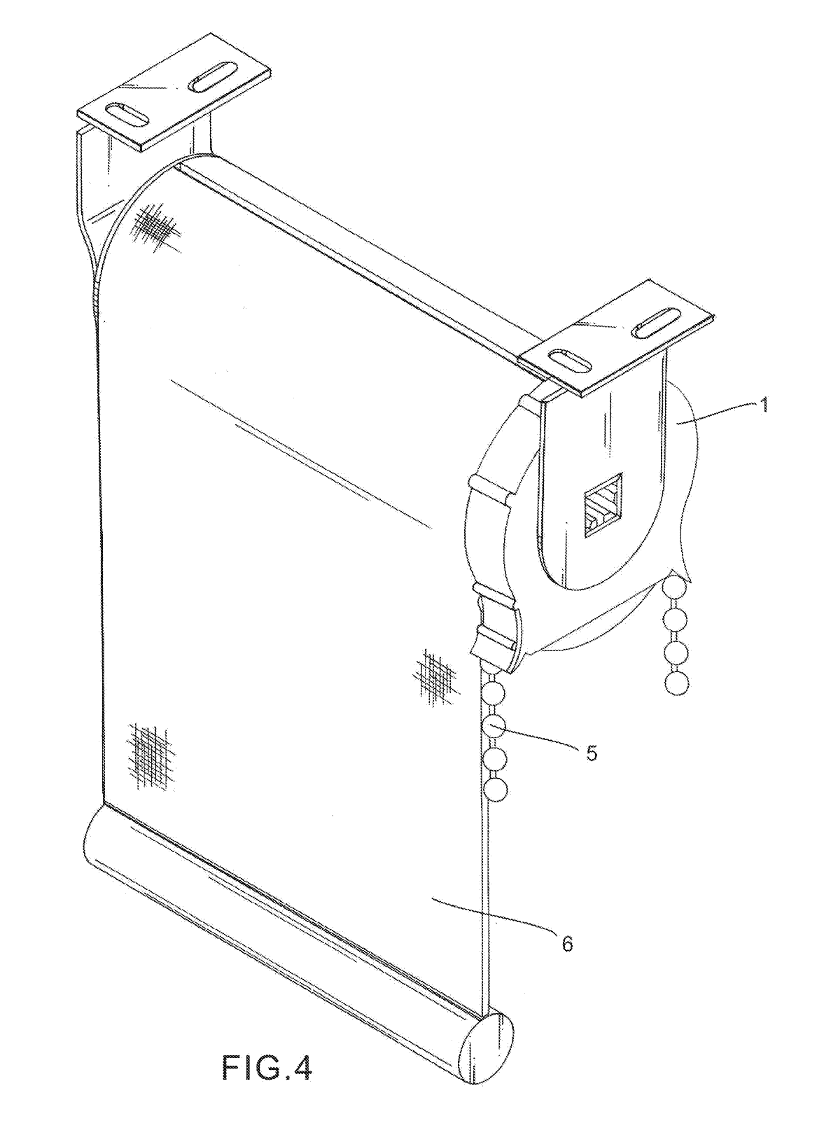

As aforesaid, the pull cord reel 2 is spaced from the inner face of the cap 1 by the collar 13 to form a gap 100 for preventing the pull cord reel 2 from contacting with the bottom wall of the receiving space 10. Therefore, when the bead pull cord 5 is pulled to operate the roller curtain 6 up and down (as shown in FIG. 4), the pull cord reel 2 will not abrade the bottom wall of the receiving space 10 to make noise in rotation. In addition, the connection section 131 of the collar 13 has a cylindrical body with a polished face for fitting and connecting with the control seat 22. Therefore, when rotating the control seat 22 around the polished face, the frictional noise is reduced to achieve a silencing effect.

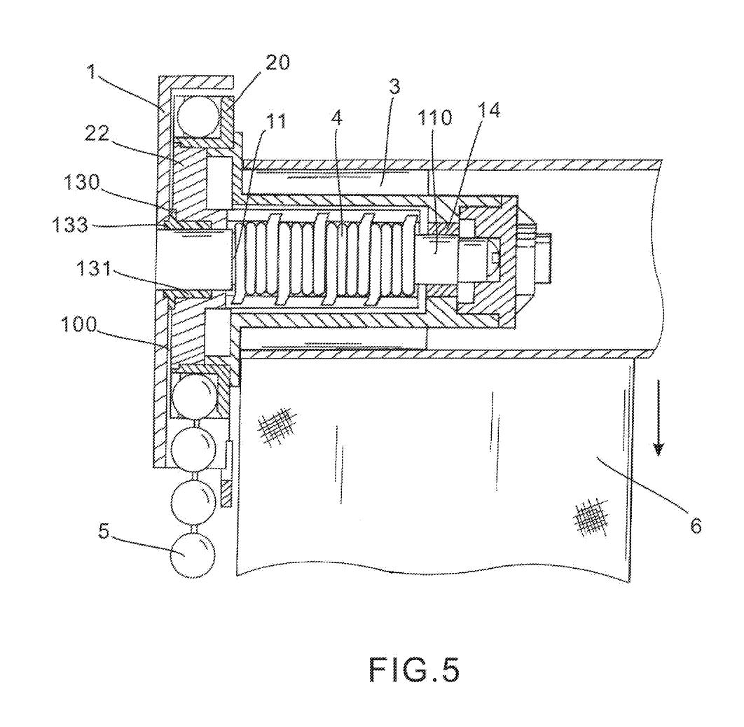

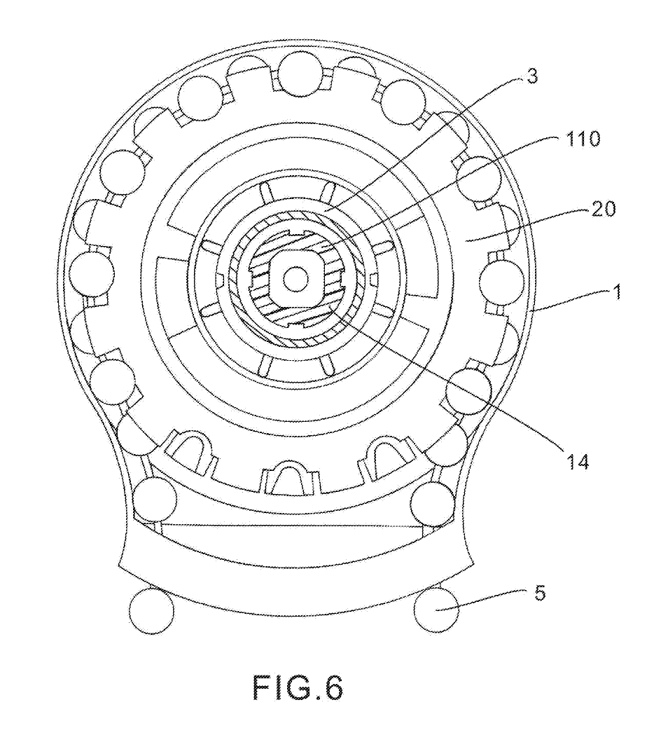

The components are fitted around the restriction stem 11 to control winding/unwinding of the roller curtain. Therefore, the restriction stem 11 will bear the weight of the entire assembly and the downward pulling force in operation (as shown in FIG. 5). Under such circumstance, the central axis of the restriction stem 11 is likely to be downward deflected under the gravity. This will lead to unsmooth operation of the roller curtain. In the present invention, to locate and keep the central axis of the restriction stem 11 in a horizontal state, a locating block 14 is especially fitted on the front end of the restriction stem 11 and insert-connected with the outer sleeve 3. In this case, the restriction stem 11 is supported to keep the central axis thereof in the horizontal position (as shown in FIG. 6). Accordingly, the restricting stem 11 is able to bear the weight of the entire assembly and the downward pulling force in operation without affecting the smoothness of operation.

The above embodiment is only used to illustrate the present invention, not intended to limit the scope thereof. Many modifications of the above embodiment can be made without departing from the spirit of the present invention.

What is claimed is:

1. A roller curtain controller comprising a cap, a collar, a locating block, a pull cord reel and an outer sleeve, the cap being recessed to form a receiving space, the cap having a restriction stem protruding from a center of bottom wall of the receiving space, engagement notches being respectively formed on two sides of a fixed end of the restriction stem for locating the collar on the restriction stem, the collar having a central through hole, a flange and a connection section protruding from an end face of the flange, engagement blocks being disposed on two sides of the through hole corresponding to the engagement notches, whereby the collar is fitted on the restriction stem with the engagement blocks fixedly engaged in the engagement notches at the fixed end of the restriction stem, the pull cord reel being connected to the connection section with the pull cord reel received in the receiving space, the pull cord reel being spaced from the bottom wall of the receiving space of the cap by the collar to form a gap for preventing the pull cord reel from contacting with the bottom wall of the receiving space, the locating block being fitted on a front end of the restriction stem, the locating block having a main body and multiple longitudinal insertion dents annularly formed on an outer circumference of the main body, multiple insertion blocks being disposed on an inner circumference of the outer sleeve, the insertion blocks being correspondingly inserted in the insertion dents of the locating block to assemble the locating block with the outer sleeve, whereby by means of the support of the locating block, a central axis of the restricting stem is prevented from being deflected under the weight of the roller curtain so that the roller curtain can be operated up and down more smoothly.

2. The roller curtain controller as claimed in claim 1, wherein the collar is made of rubber material with polished face.

3. The roller curtain controller as claimed in claim 1, wherein the connection section of the collar has a cylindrical body with a polished outer face.
